(19) United States
(12) Patent Application Publication
(10) Pub. No.: US 2013/0147721 A1
(43) Pub. Date: Jun. 13, 2013

(54) Device for Operating Touch Screen Devices in a Protective Housing

(71) Applicants: Benjamin McGeever, Shoreline, WA (US); David P. Heiss, Everett, WA (US)

(72) Inventors: Benjamin McGeever, Shoreline, WA (US); David P. Heiss, Everett, WA (US)

(21) Appl. No.: 13/316,632

(22) Filed: Dec. 12, 2011

(51) Int. Cl. G06F 3/041

(52) U.S. Cl. 345/173

(57) ABSTRACT

A protective device for use with a touch screen device includes a housing, a transparent member configured to engage with the housing, wherein the housing and the transparent member form a chamber sized to receive the touch screen device, the chamber being protected from an environment outside the protective device, an outside assembly positioned in a vicinity of an outer surface of the transparent member, an inside assembly positioned in the vicinity of an inner surface of the transparent member, a button, and a remote actuation mechanism configured to create an input to the touch screen device upon actuation of the button. The inside assembly is configured to move in tandem with the outside assembly.

### BACKGROUND

Due to advancing technology, the use of electronic touch screen devices has become widespread. As cost decreases and power increases, electronic touch screen devices are being used in a greater assortment of applications for a variety of consumer products. However, such devices are still not readily accessible for use in harsh environments where robust protection from such things as water, chemicals, pressure, and the like is necessary.

Light protection of touch screen devices has been addressed with external housings that allow operation of the touch screen through a thin membrane. Nonetheless, no device currently exists that allows the operation of a touch screen through a robust protective housing.

### SUMMARY

An aspect of the present disclosure relates to a protective device for use with a touch screen device, the protective device including: a housing; a transparent member configured to engage with the housing, wherein the housing and the transparent member form a chamber sized to receive the touch screen device, the chamber being protected from an environment outside the protective device; an outside assembly positioned in a vicinity of an outer surface of the transparent member; an inside assembly positioned in a vicinity of an inner surface of the transparent member; an electrically conductive piece capable of creating an input to the touch screen device; a switch configured to control when the electrically conductive piece creates an input to the touch screen device; a switch operator configured to activate the switch; and a button, wherein actuation of the button triggers the switch operator to activate the switch to create an input to the touch screen device. The inside assembly is configured to move in tandem with the outside assembly across the transparent member.

Another aspect of the present disclosure relates to a protective device for use with a touch screen device, the protective device including: a housing; a transparent member configured to engage with the housing, wherein the housing and the transparent member form a chamber sized to receive the touch screen device, the chamber being protected from an environment outside the protective device; an outside assembly positioned in a vicinity of an outer surface of the transparent member; an inside assembly positioned in a vicinity of an inner surface of the transparent member; an electrically conductive piece capable of creating an input to the touch screen device when moved to a position relative to the touch screen device; a button; and a remote actuation mechanism configured to transfer motion between the button and the electrically conductive piece to create an input to the touch screen device upon actuation of the button. The inside assembly configured to move in tandem with the outside assembly.

Another aspect of the present disclosure relates to s protective device for use with a touch screen device, the protective device including: a housing; a transparent member configured to engage with the housing, wherein the housing and the transparent member form a chamber sized to receive the touch screen device, the chamber being protected from an environment outside the protective device; an outside assembly positioned in a vicinity of an outer surface of the transparent member; an inside assembly positioned in the vicinity of an inner surface of the transparent member; a button; and a remote actuation mechanism configured to create an input to the touch screen device upon actuation of the button. The inside assembly is configured to move in tandem with the outside assembly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic plan view of an embodiment of a touch screen device;

FIG. 2 is an exploded schematic diagram illustrating an embodiment of an assembly of a protective housing device for use with a touch screen device;

FIG. 3 is a schematic diagram of an embodiment of the protective housing device of FIG. 2;

FIG. 4 is a schematic diagram of an embodiment of a protective housing device utilizing magnetic forces as a motion transfer mechanism;

FIG. 5 is a schematic diagram of an embodiment of a protective housing device utilizing a mechanical linkage as a motion transfer mechanism;

FIG. 6 is a schematic diagram of an embodiment of a protective housing device utilizing a remote actuation mechanism; and

FIG. 7 is a flow diagram of an embodiment of a method for operating a protective housing device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

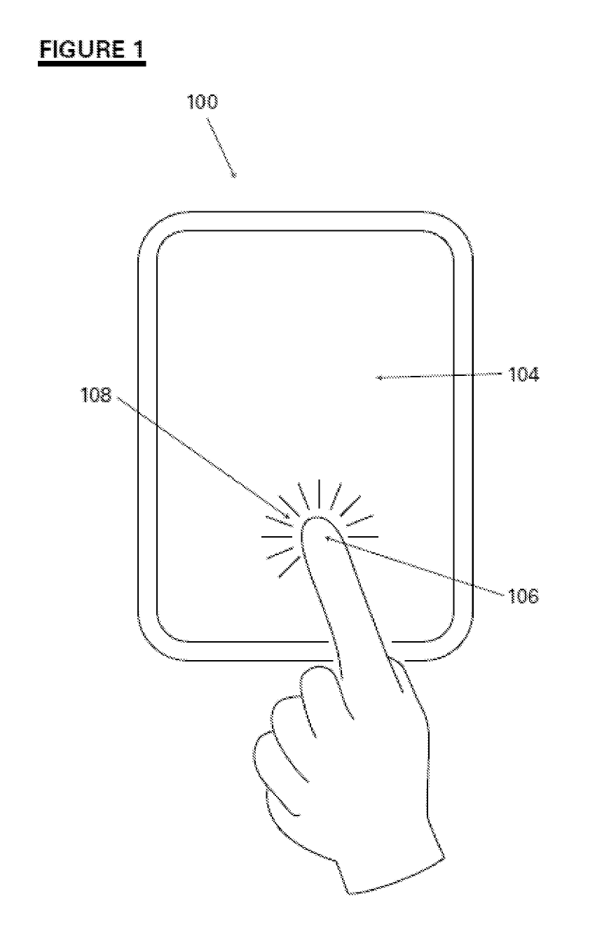

Now referring to FIG. 1, an example electronic touch screen device, generally designated 100, is shown. The touch screen device 100 includes a touch screen 104, which may be either resistive or capacitive, in alternative embodiments. In examples described herein, the touch screen 104 is capacitive. Other technologies can be used.

The touch screen device 100 can be operated via input it receives through varying degrees of contact with the touch screen 104. For example, as shown, a finger 106 may touch or come close to the touch screen 104, thereby creating a touch event 108, generating an input to the touch screen device 100. Alternatively, the touch event 108 may be initiated when other objects touch or come close to the touch screen 104, such as, for example, a stylus, or any other similar object.

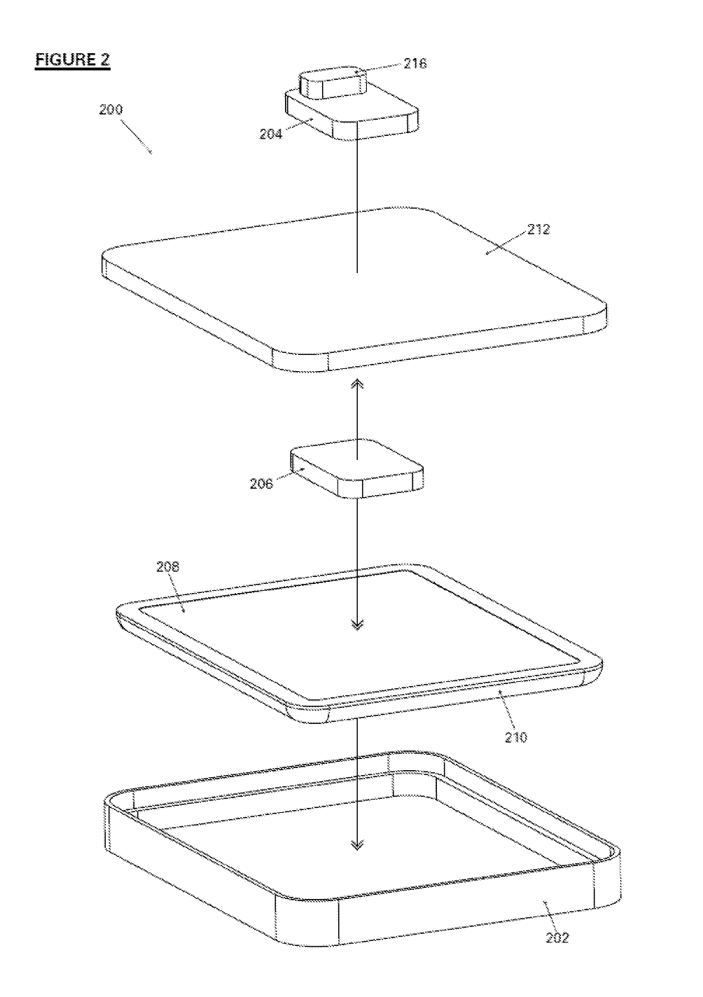

Now referring to FIG. 2, an embodiment of an assembly of a protective housing device, generally designated 200, for a touch screen device 210, is shown. A protective housing 202 includes a transparent member 212, an inside assembly 206, and an outside assembly 204. The outside assembly 204 further includes a button 216, which creates an input to the touch screen device 210, when actuated.

As shown, when the protective housing device 200 is assembled, the touch screen device 210 fits within the protective housing 202. The transparent member 212 having the inside assembly 206 and the outside assembly 204 on either side, is assembled above a touch screen 208 of the touch screen device 210.

In this example, the outside assembly 204 is positioned outside the protective housing device 200, and the inside assembly 206 is positioned within the protective housing device 200. In assembled form, the outside assembly 204 is in contact with or in the vicinity of the transparent member 212, and the inside assembly 206 is in contact with or in the vicinity of an opposite side of the transparent member 212.

When assembled, the protective housing 200 protects the touch screen device 210 from contact with the outside environment. The protective housing 202 and the transparent member 212, forming the protective chamber for the touch screen device 210, are shown for simplicity as two parts. However, in some embodiments, they may in fact be more complex assemblies of multiple parts. For example, in some embodiments, the protective housing 202 and the transparent member 212 may be sealed through various methods, such as, o-rings, adhesives, or welding to prevent the external environment from damaging the touch screen device 210. In some embodiments, the sealing may be strong enough to protect the touch screen device 210 from extreme environments, such as hundreds of feet below water and surroundings including explosive gases. In other embodiments, the touch screen device 210 may not even be removable from the protective housing 202. Instead, the touch screen device 210 may be affixed to the protective housing 200, may include features such as electrical connections for charging, etc.

The protective housing device 200 generally functions as follows when used. A user places the touch screen device 210 within the protective housing 202 and under the transparent member 212. Upon fastening the protective housing device 200, the user is free to move the outside assembly 204 to any desired position on the transparent member 212 above the touch screen 208. Thereafter, the user actuates the button 216 which triggers an internal mechanism to create an input to the touch screen device 210. In some embodiments, the internal mechanism creating the input is visible through the transparent member 212, which allows the user to move the internal mechanism and create an input to the touch screen 208 at any desired position. In this way, the user may operate the touch screen device 210 within a robust protective layer without having direct contact with the touch screen device 210.

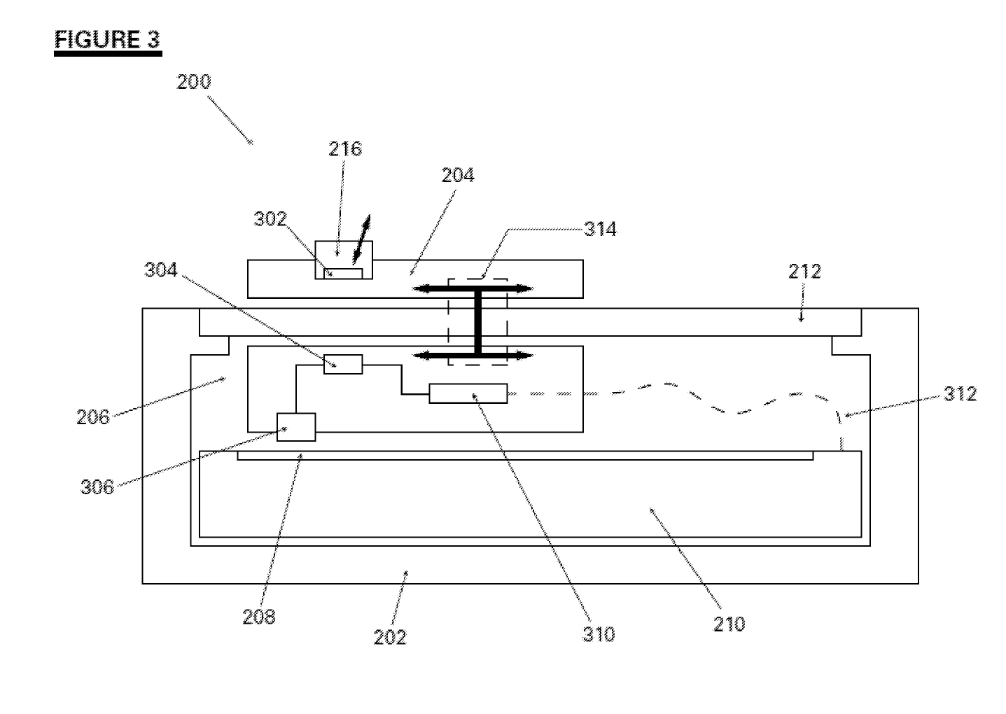

Now referring to FIG. 3, an embodiment of the protective housing device 200 of FIG. 2 is shown. The outside assembly 204 and the inside assembly 206 contain a motion transfer mechanism 314, which acts to transfer motion from the outside assembly 204, through the transparent member 212, and to the inside assembly 206. Thus, due to the motion transfer mechanism 314, the outside assembly 204 and the inside assembly 206 move in tandem with the other. Therefore, movement of the outside assembly 204 over the transparent member 212 causes the same movement of the inside assembly 206.

A user may position the outside assembly 204, and therefore the inside assembly 206, over any desired location on the touch screen 208. Thereafter, the user can actuate the button 216 to create an input to the touch screen device 210 at the desired location on the touch screen 208. In the present embodiment, the touch screen is visible under the transparent member 212. In alternative embodiments, the transparent member 212 may allow various degrees of light to transfer through its outer surface; therefore, the transparent member 212 may have the property of transparency, translucency, semi-opacity, or any other property capable of allowing some degree of light through its surface.

The inside assembly 206 includes an electrically conductive piece 306 which moves with the inside assembly 206 as a user shifts it. The electrically conductive piece 306 may be any electrically conductive member known in the art, such as, for example, a cylinder of a conductive material such as metal (e.g., aluminum) or a coil of wire. Specifically, the electrically conductive piece 306 is sized and positioned relative to the touch screen 208 so as to create an input to the touch screen device 210 when electrically interacting with an interaction device 310.

When actuated, the button 216 triggers a switch operator 302. Once triggered, the switch operator 302 remotely activates an electrical switch 304 which controls whether the electrically conductive piece 306 is electrically connected or disconnected to the interaction device 310. If disconnected, the electrically conductive piece 306 does not create a sufficient electrical interaction with the touch screen 208 to create a touch event. If connected, however, the electrically conductive piece 306 creates a sufficient electrical interaction with the touch screen 208 to create a touch event, such as, for example, touch event 108.

To create a sufficient electrical interaction with the touch screen 208, the interaction device 310 may include various passive and/or active components to create the touch event 108. However, other embodiments of the interaction device 310 exist. For example, the interaction device 310 may be a complex circuit of electrical components or it may simply be a short length of wire, a trace on a printed circuit board, a long lead wire on a reed switch, or the like.

In alternative embodiments, the interaction device 310 may be electrically coupled to the touch screen device 210 via a wire 312 for a variety of reasons, such as, for example, if required to cause a touch event or for electrical power. Furthermore, the interaction device 310 may itself include a power source if necessary for the application. In yet further embodiments, the interaction device 310 and the electrical switch 304 may be replaced with only one component or assembly capable of performing the tasks of both the interaction device 310 and the electrical switch 304.

Further, the interaction device 310, the electrical switch 304, the switch operator 302, and/or the button 216 may be positioned in varying locations on the protective housing device 200. For example, in an alternative embodiment, the button 216 can be positioned on a bezel of the housing rather than on the outside assembly 204.

The electrically conductive piece 306 may be sized differently in various embodiments to provide sufficient electrical interaction with the touch screen 206. Specifically, the electrically conductive piece 306 is sized such that when connected electrically to the interaction device 310 and in a position close to or in contact with the touch screen 206, it creates a touch event, such as the touch event 108. However, in other embodiments, it is also sized such that when electrically connected to the interaction device 310, but in a position away from the touch screen 208, it does not provide sufficient electrical interaction with the touch screen 208 to cause a touch event, such as the touch event 108.

Therefore, the size and design of the electrically conductive piece 306 is dependent on various factors including, but not limited to, the type of touch event needed for the type of touch screen device utilized. For example, in some embodiments, the type of touch event needed for a resistive touch screen may differ from the type of touch event needed for a capacitive touch screen.

Furthermore, the electrical switch 304 and the switch operator 302 may utilize any suitable technology. In some embodiments, the electrical switch 304 and the switch operator 302 may operate through the use of magnetics, such as, for example, through the use of a reed switch or a Hall Effect sensor and a magnet. In alternate embodiments, the electrical switch 304 and the switch operator 302 may operate utilizing optics, such as, for example, through the use of a light emitting diode and a sensor. In yet further embodiments, either component could be a collection of electrical and electronic parts which act together to create a switching mechanism. If implementation of the electrical switch 304 and/or the switch operator 302 or any other associated parts requires electrical power, the touch screen device 210 may provide such power via the wire 312. Alternatively, a power source (not shown) may be included in the protective housing device 200. Various other embodiments may exist to provide appropriate levels of electrical power to the device 200 as necessary.

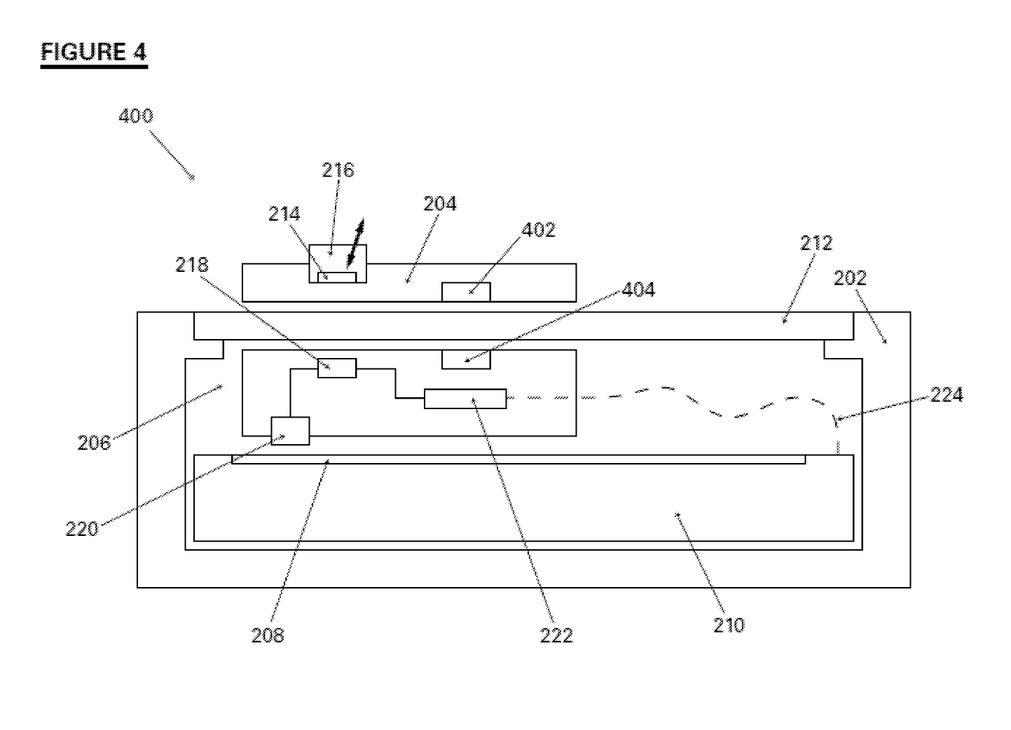

Now referring to FIG. 4, another embodiment of a protective housing device, generally designated 400, for a touch screen device 210, is shown. Specifically, the protective housing device 400 utilizes two magnets 402, 404 as a motion transfer mechanism. Such a configuration is one embodiment of the motion transfer mechanism 314 of the protective housing device 200 of FIG. 3.

In the example embodiment, the magnets 402, 404 are arranged so that their magnetic forces act to transfer any motion from the outside assembly 204 to the inside assembly 206. The magnets 402, 404 may also be arranged so that their magnetic forces further act to fasten the outside assembly 204 and the inside assembly 206 to the transparent member 212.

For example, in this embodiment, the magnets 402, 404 are positioned so that they are magnetically attracted to one another. In this configuration, the magnets 402, 404 hold the outside and inside assemblies 204, 206 against the opposite sides of the transparent member 212, and cause the inside assembly 206 to follow the outside assembly 204 as the user moves the outside assembly 204 along the transparent member 212. During disassembly, the magnetic attraction between the magnets 402, 404 can be overcome when enough force is applied so that the outside and inside assemblies 204, 206 can be uncoupled and removed from the transparent member 212. In alternative embodiments, the magnets 402, 404 may include a plurality of magnets arranged in a variety of techniques to better achieve their motion transfer and/or fastening functions.

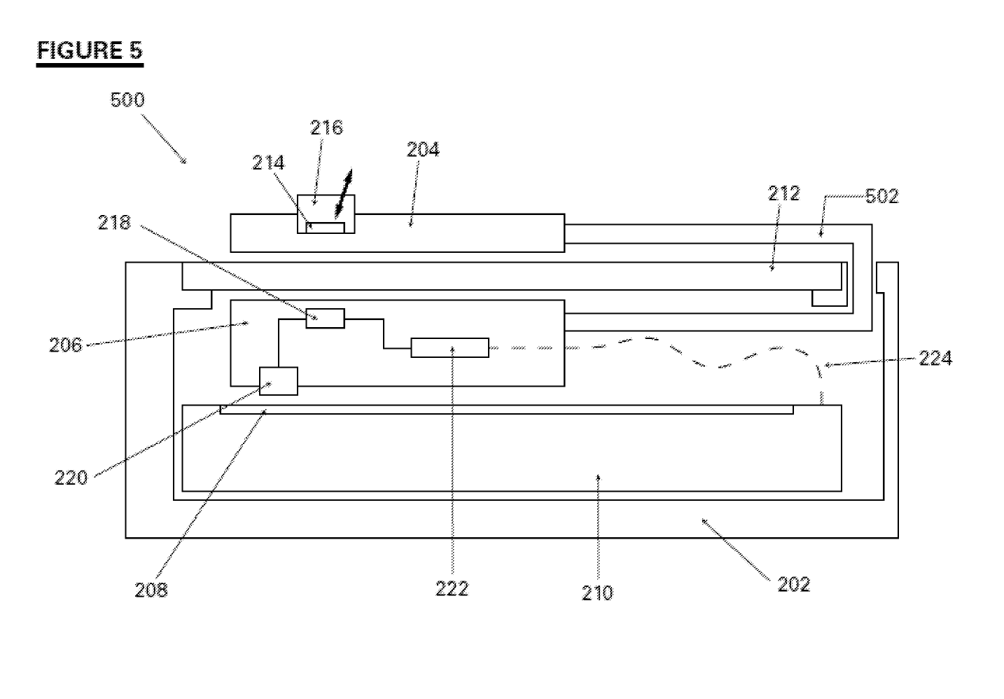

Now referring to FIG. 5, another embodiment of a protective housing device, generally designated 500, for a touch screen device 210, is shown. Specifically, the protective housing device 500 utilizes a mechanical linkage 502 as a motion transfer mechanism. Such a configuration is one embodiment of the motion transfer mechanism 314 of the protective housing device 200 of FIG. 3. In this example, the mechanical linkage 502 functions to transfer motion from the outside assembly 204 to the inside assembly 206, similar to the magnetic embodiment described above.

In such an example, the mechanical linkage 502 can extend from outside the protective housing 500 (where the mechanical linkage 502 is coupled to the outside assembly 204) to inside the protective housing 500 (where the mechanical linkage is coupled to the inside assembly 206). To minimize any contaminants from entering the protective housing 500, the point at which the mechanical linkage 502 enters the protective housing 500 can be sealed, for example, in one embodiment, the mechanical linkage may be sealed with o-rings at the point it penetrates the protective housing 500. The mechanical linkage 502 may utilize any suitable technology, for example, in one embodiment, the linkage may be a simple pivoting bar. In other embodiments, the mechanical linkage 502 may be more complex, including multiple bars, pivots and/or cables to transfer motion.

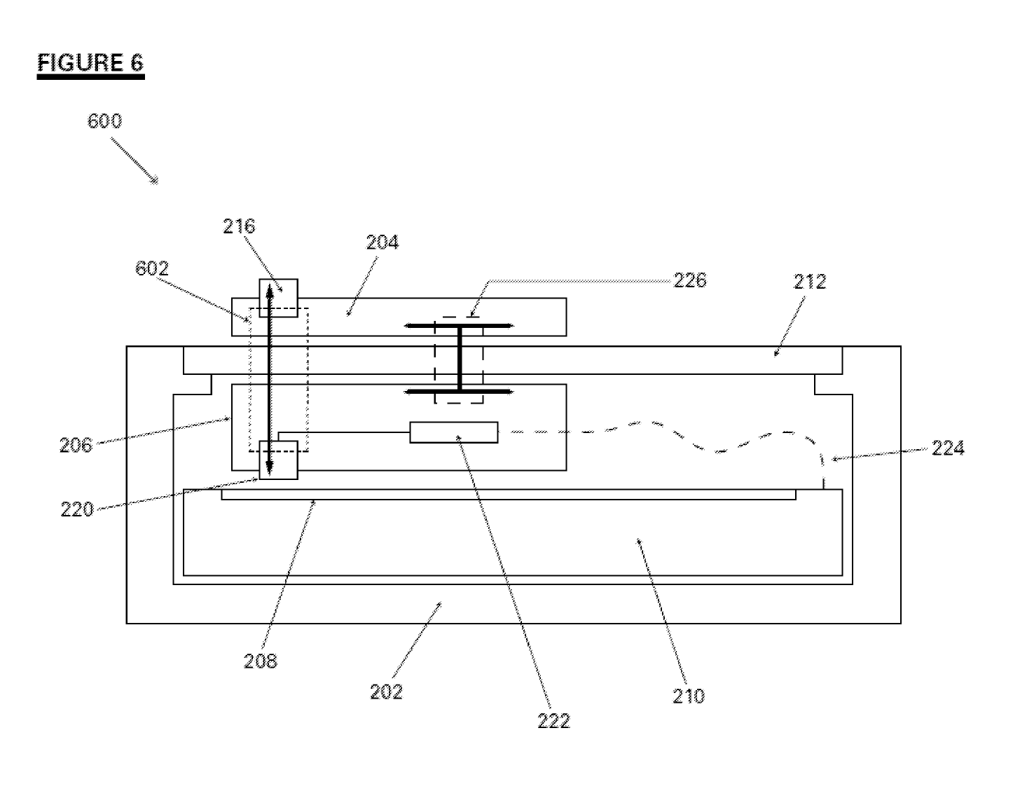

Now referring to FIG. 6, yet another embodiment of a protective housing device, generally designated 600, for a touch screen device 210, is shown. Specifically, the protective housing device 600 utilizes a remote actuation mechanism 602, which functions to transfer motion between the button 216 and the electrically conductive piece 220. The remote actuation mechanism 602 ensures that movement of the button 216 also moves the electrically conductive piece 220 between a position away from the touch screen 208 and a position close to or in contact with the touch screen 208.

The remote actuation mechanism 602 may utilize any suitable technology. For example, in one embodiment, the remote actuation mechanism 602 may include several magnets and a spring wherein the magnetic force acts to transfer motion between the button 216 and the electrically conductive piece 220. In another embodiment, the remote actuation mechanism 602 may utilize a mechanical linkage, such as, for example, an electrical system with a switch and a solenoid actuator. In yet further embodiments, various other technologies and groupings of electrical and/or mechanical components may work together to achieve the same function. The remote actuation mechanism 602, the button 204, and the electrically conductive piece 220 may be positioned in various locations on the protective housing device 600 and yet still achieve the same functions.

In the example, the electrically conductive piece 220 is permanently connected to the interaction device 222. The movement of the electrically conductive piece 220 from a position away from the touch screen 208 to a position close to or in contact with the touch screen 208, provides the trigger for the touch event 108. In other embodiments, the electrically conductive piece 220 is removably connected to the interaction device 222.

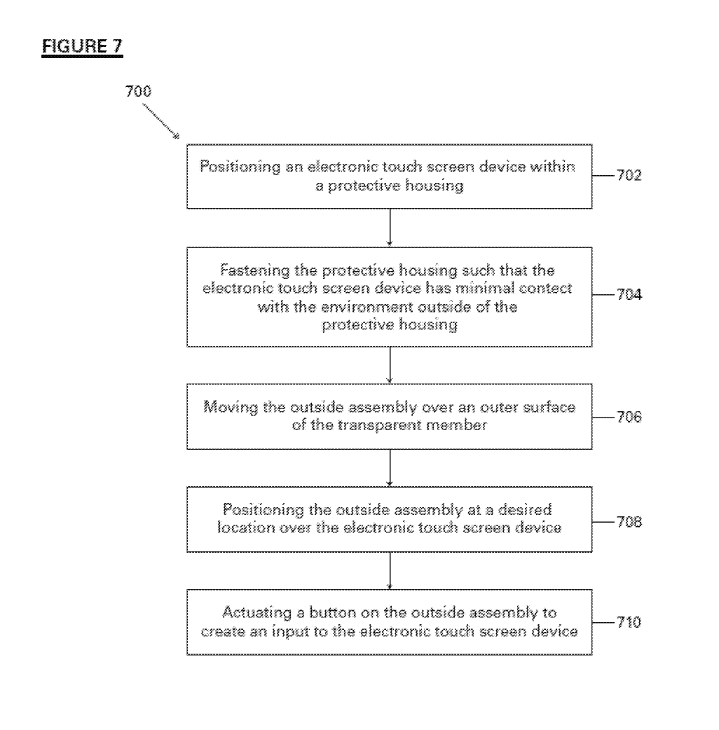

Now referring to FIG. 7, a method 700 for operating a protective housing device is shown. The method 700 can be better understood with reference to the protective housing device 200 in FIG. 2 and FIG. 3. In step 702, a user positions the touch screen device 210 within the protective housing 202. The touch screen device 210 is positioned in such a way that it rests beneath the transparent member 212, wherein the touch screen 208 is viewable under the transparent member 212. In step 704, the user fastens the protective housing 202 such that the touch screen device 210 has minimal contact with the environment outside the protective housing device 200. In the subject embodiment, and by way of example only, the protective housing 210 is fastened together with the transparent member 212, thereby confining the touch screen device 210 within the device 200.

In step 706, the user moves the outside assembly 204 over an outer surface of the transparent member 212. The user may guide the outside assembly 204 to any position over the transparent member 212 by viewing the touch screen 208 which is visible under the transparent member 212. In step 708, the user positions the outside assembly 204 at a desired location over the touch screen device 210. The desired location may be any point within the boundaries of the touch screen 208 at which the user wishes to create a touch event. Finally, in step 710, the user actuates the button 216, located on the outside assembly 204, to create an input to the touch screen device 210. Thus, by actuating the button 216, the user creates a touch event at the desired location on the touch screen 208.

In the subject embodiment, and by way of example only, actuating the button 216, triggers the switch operator 302. Once triggered, the switch operator 302 remotely activates the electrical switch 304 which controls the electrically conductive piece 306, thereby controlling the occurrence of a touch event. Specifically, the electrical switch 304 controls whether the electrically conductive piece 306 is electrically connected or disconnected from the interaction device 310. If the electrically conductive piece 306 is connected to the interaction device 310, the active and/or passive components of the interaction device 310, combined with the electrically conductive piece 306, create a sufficient electrical interaction with the touch screen 208 to cause a touch event. However, if the electrically conductive piece 306 is disconnected from the interaction device 310, less than sufficient electrical interaction exists between the electrically conductive piece 306 and the touch screen 208 to create a touch event.

There can be various advantages associated with the protective housing device described herein. In some embodiments, it is advantageous to increase the size and/or rigidity of the protective housing device so that it can be utilized in varying outside environments. For example, the protective housing, transparent member, outside assembly, and inside assembly may be sized so that such components may be functional underwater or in varying temperatures, environments, settings, surroundings, etc. Furthermore, the materials utilized in constructing the protective housing device may also differ based on the applications and functions desired.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A protective device for use with a touch screen device, the protective device comprising:
a housing;
a transparent member configured to engage with the housing, wherein the housing and the transparent member form a chamber sized to receive the touch screen device, the chamber being protected from an environment outside the protective device;
an outside assembly positioned in a vicinity of an outer surface of the transparent member;
an inside assembly positioned in a vicinity of an inner surface of the transparent member;
an electrically conductive piece capable of creating an input to the touch screen device;
a switch configured to control when the electrically conductive piece creates an input to the touch screen device;
a switch operator configured to activate the switch; and
a button, wherein actuation of the button triggers the switch operator to activate the switch to create an input to the touch screen device;
wherein the inside assembly is configured to move in tandem with the outside assembly across the transparent member.

2. A protective device as claimed in claim 1, wherein a configuration to move the inside assembly and the outside assembly in tandem comprises at least two magnets, the magnets coupled to the outside assembly and the inside assembly and arranged such that magnetic forces act to transfer motion of the outside assembly to the inside assembly.

3. A protective device as claimed in claim 2 wherein the magnets are arranged such that magnetic forces couple the outside assembly and the inside assembly to the transparent member.

4. A protective device as claimed in claim 1, wherein a configuration to move the inside and outside assembly in tandem comprises a mechanical linkage

5. A protective device as claimed in claim 1, wherein the electrically conductive piece is a coil of wire.

6. A protective device as claimed in claim 1, wherein the switch operator and the switch comprise a magnet and a reed switch.

7. A protective device as claimed in claim 1, further comprising an interaction device, wherein, when the electrically conductive piece is electrically coupled to the interaction device, the interaction device creates an input to the touch screen device.

8. A protective device as claimed in claim 7, wherein the interaction device is electrically connected to at least one of the protective device and the touch screen device.

9. A protective device as claimed in claim 8, wherein the electrically conductive piece is a cylinder of metal, the switch operator and the switch comprise a magnet and a reed switch, the interaction device is electrically connected to the touch screen device, and the interaction device is simply an electrical connection between the switch and electrical connection to the touch screen device.

10. A protective device for use with a touch screen device, the protective device comprising:
a housing;
a transparent member configured to engage with the housing, wherein the housing and the transparent member form a chamber sized to receive the touch screen device, the chamber being protected from an environment outside the protective device;
an outside assembly positioned in a vicinity of an outer surface of the transparent member;
an inside assembly positioned in a vicinity of an inner surface of the transparent member;
an electrically conductive piece capable of creating an input to the touch screen device when moved to a position relative to the touch screen device;
a button; and
a remote actuation mechanism configured to transfer motion between the button and the electrically conductive piece to create an input to the touch screen device upon actuation of the button;
wherein the inside assembly configured to move in tandem with the outside assembly.

11. A protective device as claimed in claim 10, wherein a configuration to move the inside assembly and the outside assembly in tandem comprises at least two magnets, the magnets coupled to the outside assembly and the inside assembly and arranged such that magnetic forces act to transfer motion.

12. A protective device as claimed in claim 11, wherein the magnets are also arranged such that the magnetic forces couple the outside assembly and the inside assembly to the transparent member.

13. A protective device as claimed in claim 11, wherein the configuration to move the inside assembly and the outside assembly in tandem comprises a mechanical linkage

14. A protective device as claimed in claim 11, further comprising an interaction device, wherein, when the electrically conductive piece is electrically coupled to the interaction device, the interaction device creates an input to the touch screen device.

15. A protective device as claimed in claim 14, wherein the interaction device is electrically connected to at least one of the protective device and the touch screen device.

16. A protective device as claimed in claim 15, wherein the interaction device is another electrically conductive piece capable of creating an input to the touch screen device

17. A protective device as claimed in claim 11, wherein the remote actuation mechanism comprises at least two magnets and a spring.

18. A protective device as claimed in claim 11, wherein the remote actuation mechanism comprises an electrical switch and a solenoid actuator.

19. A protective device for use with a touch screen device, the protective device comprising:
a housing;
a transparent member configured to engage with the housing, wherein the housing and the transparent member form a chamber sized to receive the touch screen device, the chamber being protected from an environment outside the protective device;
an outside assembly positioned in a vicinity of an outer surface of the transparent member;
an inside assembly positioned in the vicinity of an inner surface of the transparent member;
a button; and
a remote actuation mechanism configured to create an input to the touch screen device upon actuation of the button;
wherein the inside assembly is configured to move in tandem with the outside assembly.

20. A method for operating a protective device, comprising:
positioning a touch screen device within a housing of the protective device; the protective device further comprising an outside assembly and a transparent member;
fastening the housing such that the touch screen device minimizes contact with an environment outside of the protective device;
moving the outside assembly over an outer surface of the transparent member, the touch screen device viewable under the transparent member;
positioning the outside assembly at a desired location over the touch screen device; and
actuating a button thereby creating an input to the touch screen device.
